(19) United States
(12) Patent Application Publication
(10) Pub. No.: US 2020/0398677 A1
(43) Pub. Date: Dec. 24, 2020

(54) WIND SCOOP CHARGING SYSTEM

(71) Applicant: K&N Engineering, Inc., Riverside, CA (US)

(72) Inventors: Jonathan Richard Fiello, Yucaipa, CA (US); Steve Williams, Cherry Valley, CA (US)

(73) Assignee: K&N Engineering, Inc., Riverside, CA (US)

(21) Appl. No.: 16/905,142

(22) Filed: Jun. 18, 2020

Related U.S. Application Data
(60) Provisional application No. 62/864,962, filed on Jun. 21, 2019.

(51) Int. Cl. B60L 8/00; F03D 9/32; F03D 9/25; H02J 7/34

(52) U.S. Cl. CPC B60L 8/006; F03D 9/32; F05B 2240/60; H02J 7/34; F05B 2220/706; F03D 9/25

(57) ABSTRACT

A system and methods are provided for a wind scoop charging system for recharging onboard batteries during operation of an electrically powered vehicle. The wind scoop charging system comprises a wind scoop configured to be coupled with a hood of the vehicle. One or more air inlets are disposed in the wind scoop to receive an airstream during forward motion of the vehicle. A wind turbine is disposed within the wind scoop and rearward of the air inlet. The wind turbine is configured to produce an electric current upon being turned by the airstream. A power cable is configured to direct the electric current from the wind turbine to one or more electronic devices that are configured to utilize the electric current. The electronic devices may include any of an onboard battery for powering the vehicle, mobile phones or smart phones, portable music players, tablet computers, cameras, and the like.

### PRIORITY

This application claims the benefit of and priority to U.S. Provisional Application, entitled “Wind Scoop Charging System,” filed on Jun. 21, 2019 and having application Ser. No. 62/864,962, the entirety of said application being incorporated herein by reference.

### FIELD

Embodiments of the present disclosure generally relate to the field of electrically powered vehicles. More specifically, embodiments of the disclosure relate to a wind scoop charging system and methods for recharging onboard batteries during operation of an electrically powered vehicle.

### BACKGROUND

Electrically powered vehicles generally solve problems associated with the gasoline-powered vehicles, such as environmental pollution, noise and depletion of crude oil reserves due to the increasing use of gasoline-powered vehicles. As such, electrically powered vehicles are gaining in popularity and their use is becoming increasingly widespread. Unfortunately, electrically powered vehicles have certain drawbacks, including limited travel range between battery recharging and excessive time required for recharging the batteries. In generally, the average travel distance between battery recharging for currently available electrically powered vehicles is considerably less than the driving range of gasoline powered vehicles. Further, several hours may be required to recharge the batteries while the vehicle remains inoperative.

Increasing the driving range of electrically powered vehicles between battery recharging downtimes can significantly increase the desirability of operating electrically powered vehicles. One approach to increasing the driving range of electrically powered is by charging the batteries while the vehicle is in motion, such as by way of utilizing air currents as a motive power. Although there have been many contributions to the art of electrically powered vehicles, significant improvements are needed to solve the short travel distance problems associated with such vehicles. There is a continuing interest, therefore, in developing battery recharging systems capable of extending the driving range of electrically powered vehicles during vehicle operation.

### SUMMARY

A system and methods are provided for a wind scoop charging system for recharging onboard batteries during operation of an electrically powered vehicle. The wind scoop charging system comprises a wind scoop configured to be coupled with a hood of the vehicle. One or more air inlets are disposed in the wind scoop to receive an airstream during forward motion of the vehicle. A wind turbine is disposed within the wind scoop and rearward of the air inlet. The wind turbine is configured to produce an electric current upon being turned by the airstream. A power cable is configured to direct the electric current from the wind turbine to one or more electronic devices that are configured to utilize the electric current. The electronic devices may include any of an onboard battery for powering the vehicle, mobile phones or smart phones, portable music players, tablet computers, cameras, and the like.

In an exemplary embodiment, a charging system for a vehicle comprises: a wind scoop configured to be coupled with a hood of the vehicle; one or more air inlets disposed in the wind scoop and configured to receive an airstream during forward motion of the vehicle; a wind turbine disposed within the wind scoop and rearward of the one or more air inlets, the wind turbine being configured to be turned by the airstream; and a power cable configured to direct an electric current from the wind turbine to one or more electronic devices that are configured to utilize the electric current.

In another exemplary embodiment, the one or more electronic devices comprises any of an onboard battery for powering the vehicle, mobile phones or smart phones, portable music players, tablet computers, cameras, and the like. In another exemplary embodiment, the wind scoop includes a shape and size suitable for being coupled with the vehicle. In another exemplary embodiment, the wind scoop includes multiple mounting holes for receiving hardware fasteners suitable for attaching the wind scoop to the hood of the vehicle.

In another exemplary embodiment, the one or more air inlets comprises a single air inlet configured to receive the airstream during forward motion of the vehicle. In another exemplary embodiment, one or more air outlet ports are disposed at a rear of the wind scoop and configured to allow the airstream to exit the wind scoop.

In another exemplary embodiment, the wind turbine includes multiple blades coupled with a hub that is in mechanical communication with one or more electric generators. In another exemplary embodiment, the multiple blades generally are arranged in a cylindrical configuration. In another exemplary embodiment, each of the multiple blades includes a scooped cross-sectional shape that extends along the length of the blade. In another exemplary embodiment, the multiple blades are configured to turn the one or more electric generators in response to the airstream entering through the one or more air inlets and exiting through one or more air outlet ports at a rear of the wind scoop. In another exemplary embodiment, transmission gears are configured to communicate rotation of the multiple blades and the hub to a shaft extending to each of the one or more electric generators. In another exemplary embodiment, the transmission gears and the shafts are configured to cause the one or more electric generators to produce an electric current in response to rotation of the multiple blades.

In another exemplary embodiment, the multiple blades are configured to be axially mounted onto the hood such that the multiple blades remain free to rotate. In another exemplary embodiment, the charging system further includes a circuit box configured to combine the electric current from the one or more electric generators into a combined, useable electric current. In another exemplary embodiment, the charging system further includes a power cable extending from the circuit box and configured to direct the useable electric current to one or more electronic devices.

In an exemplary embodiment, a method for a charging system for a vehicle comprises: configuring a wind scoop to be coupled with a hood of the vehicle; disposing one or more air inlets in the wind scoop; configuring the one or more air inlets to receive an airstream during forward motion of the vehicle; forming one or more air outlet ports at a rear of the wind scoop; disposing a wind turbine within the wind scoop and rearward of the one or more air inlets; configuring the wind turbine to be turned by the airstream; and configuring a power cable to direct an electric current from the wind turbine to one or more electronic devices that are configured to utilize the electric current.

In another exemplary embodiment, configuring the wind turbine includes configuring multiple blades to turn one or more electric generators in response to the airstream entering through the one or more air inlets and exiting through the one or more air outlet ports. In another exemplary embodiment, configuring the wind turbine further includes coupling the multiple blades with a hub that is in mechanical communication with the one or more electric generators. In another exemplary embodiment, configuring the wind turbine further includes configuring transmission gears to communicate rotation of the multiple blades and the hub to a shaft extending to each of the one or more electric generators such that rotation of the multiple blades causes the one or more electric generators to produce the electric current. In another exemplary embodiment, configuring the power cable further includes configuring a circuit box to combine the electric current from the one or more electric generators into a combined, useable electric current. In another exemplary embodiment, configuring the power cable further includes configuring a power cable extending from the circuit box to direct the useable electric current to the one or more electronic devices.

### BRIEF DESCRIPTION OF THE DRAWINGS

The drawings refer to embodiments of the present disclosure in which:

FIG. 1 illustrates a perspective view of an exemplary embodiment of a wind scoop charging system coupled with a hood of an electrically powered vehicle, in accordance with the present disclosure; and

FIG. 2 illustrates a side cross-sectional view of an exemplary embodiment of a wind scoop charging system configured to be coupled with a hood of an electrically-power vehicle according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first battery,” may be made. However, the specific numeric reference should not be interpreted as a literal sequential order but rather interpreted that the “first battery” is different than a “second battery.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Electrically powered vehicles generally solve problems associated with the gasoline-powered vehicles, such as environmental pollution, noise and depletion of crude oil reserves due to the increasing use of gasoline-powered vehicles. As such, electrically powered vehicles are gaining in popularity and their use is becoming increasingly widespread. Drawbacks to electrically powered vehicles include limited travel range between battery recharging and excessive time required for recharging the batteries. Increasing the driving range of electrically powered vehicles between battery recharging downtimes can significantly increase the desirability of operating electrically powered vehicles. One approach to increasing the driving range of electrically powered is by charging the batteries while the vehicle is in motion, such as by way of utilizing air currents as a motive power. Embodiments disclosed herein relate to a wind scoop charging system configured to be mounted onto a vehicle for recharging an onboard battery during operation of the vehicle.

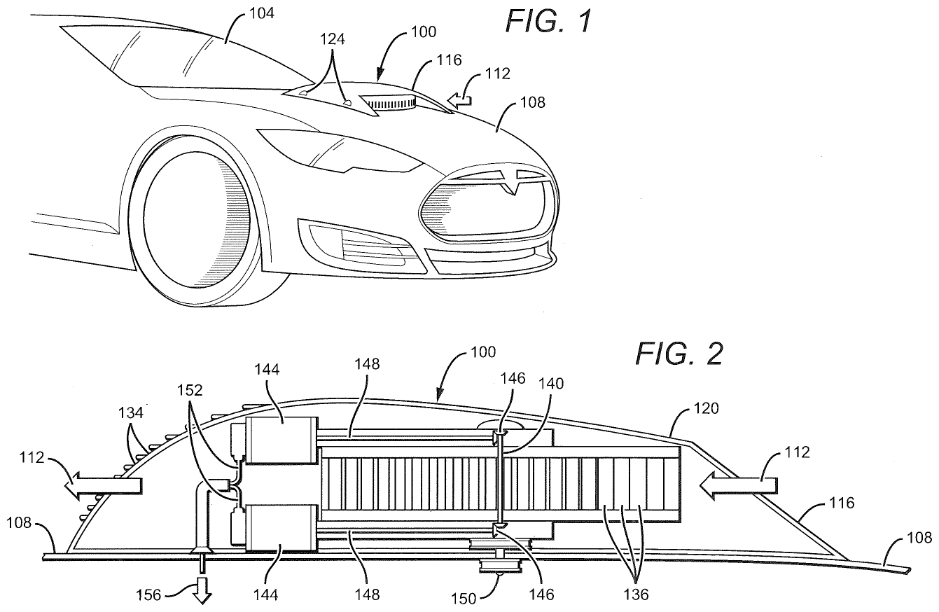

FIG. 1 illustrates a perspective view of an exemplary embodiment of a wind scoop charging system 100 coupled with an electrically powered vehicle 104, in accordance with the present disclosure. The charging system 100 is configured to be coupled with a hood 108 of the vehicle 104, such that an airstream 112 incident during forward motion of the vehicle 104 is directed into an air inlet 116. As described herein, the airstream 112 passing through the air inlet 116 operates one or more generators whereby an electric current is produced. The electric current may be used for recharging an onboard battery or powering any of various electronic devices, as desired. It is contemplated that such electronic devices may include, but are not limited to, mobile phones or smart phones, portable music players, tablet computers, cameras, and the like.

Although the vehicle 104 shown in FIG. 1, and described herein, is of an electrically powered variety, it is contemplated that the charging system 100 of the present disclosure may be coupled with a wide variety of different vehicles. For example, the vehicle 104 may be any vehicle that includes an onboard battery, such as hybrid electric vehicles, electric vehicles, as well as various fuel-powered vehicles. In some embodiments, fuel-powered vehicles may include any of automobiles, trucks, recreational vehicles, buses, various cargo moving vehicles, locomotives, airplanes, helicopters, airships, boats and ships, and the like, without limitation.

FIG. 2 illustrates a side cross-sectional view of the wind scoop charging system 100 of FIG. 1. The wind scoop charging system 100 comprises a wind scoop 120 that is configured to be coupled with the hood 108 of the vehicle 104, as shown in FIG. 1. The wind scoop 120 generally includes a shape and size suitable for being coupled with the vehicle 104. As such, the wind scoop 120 includes multiple mounting holes 124, as shown in FIG. 1 for receiving hardware fasteners suitable for attaching the wind scoop 120 to the hood 108 of the vehicle 104. As will be appreciated, any of the hardware fasteners, the number and locations of the mounting holes 124, as well as the shape and size of the wind scoop 120, may be varied, without limitation, so as to accommodate various makes and models of the vehicle 104.

As shown in FIG. 2, the wind scoop 120 includes an air inlet 116 configured to receive the airstream 112 during forward motion of the vehicle 104. In the illustrated embodiment, the wind scoop 120 includes a single air inlet 116. It is contemplated, however, that in some embodiments, more than one air inlet 116 may be incorporated into the wind scoop 120 without limitation. For example, in some embodiments, the wind scoop 120 may include two, three or more air inlets 116 disposed side-by-side, without limitation. In such embodiments, each pair of adjacent air inlets 116 may share an intervening separator configured to contribute to the structural integrity of the wind scoop 120 and to operate in combination with the air inlets 116 to reduce air turbulence. It is contemplated that any of various aerodynamic shapes or features may be incorporated into the wind scoop 120 so as to improve entry of the airstream 112 into the air inlet 116, without limitation.

A wind turbine 132 comprising the wind scoop charging system 100 is disposed rearward of the air inlet 116 and is generally surrounded by the wind scoop 120. As such, during forward motion of the vehicle 104, the airstream 112 flows through the air inlet 116 and turns the wind turbine 132 before exiting at a rear of the wind scoop 120. One or more air outlet ports 134 may be disposed at the rear of the wind scoop 120 and configured to allow the airstream 112 entering the air inlet 136 to exit through the rear of the wind scoop 120. While being turned, the wind turbine 132 produces electricity that may be used to recharge an onboard battery and/or power one or more portable electronic devices, as described herein.

With continuing reference to FIG. 2, the wind turbine 132 includes multiple blades 136 coupled with a hub 140 that is in mechanical communication with one or more electric generators 144. The blades 136 generally are arranged in a cylindrical configuration. It is contemplated that any suitable number of blades 136 may be coupled with the hub 140, without limitation. Each of the blades 136 includes a scooped cross-sectional shape that extends along the length of the blade 136. As such, the blades 136 are configured to turn the electric generators 144 in response to the airstream 112 entering through the air inlet 116 and exiting through the air outlet ports 134 at the rear of the wind scoop 120. In some embodiments, the blades 136 are configured to rotate the electric generators 144 in a clockwise direction for the purpose of producing electricity. It should be recognized, however, that the blades 136 may be configured, in some embodiments, to rotate the electric generators 144 in a counterclockwise direction, as may be desired. As such, the specific configuration of the blades 136 shown in FIG. 2 is not to be construed as limiting in nature, and thus the blades 136 may be altered to accommodate a wide variety of makes and models of electric generators 144, without limitation.

In the embodiment illustrated in FIG. 2, transmission gears 146 are configured to communicate rotation of the blades 136 and the hub 140 to a shaft 148 extending to each of the one or more electric generators 144. As will be appreciated, the transmission gears 146 and the shafts 148 are configured to cause the electric generators 144 to produce an electric current in response to rotation of the blades 136. Further, the blades 136 may be axially mounted onto the hood 108 by way of a mount 150. Any of various suitable hardware fasteners may be used to fasten the mount 150 to the hood 108. As will be recognized, one or more bearings (not shown) may be included between the mount 150 and the blades 136 such that the blades 136 are free to rotate after the mount 150 is fixated to the hood 108.

In general, during forward motion of the vehicle 104 the airstream 112 passes into the air inlet 116, wherein the airstream 112 advantageously causes the blades 136 and the electric generators 144 to rotate. As mentioned hereinabove, the electric generators 144 are configured to produce an electric current during rotating. Each electric generator 144 includes a power cable 152 that is configured to convey an electric current 156 from the electric generator 144 to one or more electronic devices configured to utilize the electric current 156, such as an onboard battery configured to power the vehicle 104.

In some embodiments, wherein the charging system 100 includes multiple electric generators 144, the electric currents 156 may be directed from the electric generators 144 to a circuit box that includes electric circuitry configured to combine the electric currents 156 into a combined, useable electric current. In some embodiments, the circuit box may be configured to synchronize AC electric currents received from the electric generators 144 to form the useable electric current. In some embodiments, the circuit box may include at least one rectifier configured to convert AC electricity received from the electric generators 144 into DC electricity in the foam of the useable electric current. Further, in some embodiments, wherein the electric generators 144 are configured to generate DC currents, the circuit box may be configured to combine the received DC currents to form the useable electric current.

Embodiments of the wind scoop charging system 100 that include the circuit box, as described above, may include a power cable that is configured to carry the useable electric current from the circuit box to any one or more electronic devices that are configured to utilize the current. It is contemplated that the useable electric current may be used for recharging an onboard battery or powering any of various electronic accessory devices, including, but not limited to, mobile phones or smart phones, portable music players, tablet computers, cameras, and the like. It is contemplated that the power cable and the circuit box may be implemented in a wide variety of configurations other than those specifically described herein, without limitation, and without deviating beyond the spirit and scope of the present disclosure.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A charging system for a vehicle, the charging system comprising:
a wind scoop configured to be coupled with a hood of the vehicle;
one or more air inlets disposed in the wind scoop and configured to receive an airstream during forward motion of the vehicle;
a wind turbine disposed within the wind scoop and rearward of the one or more air inlets, the wind turbine being configured to be turned by the airstream; and
a power cable configured to direct an electric current from the wind turbine to one or more electronic devices that are configured to utilize the electric current.

2. The charging system of claim 1, wherein the one or more electronic devices comprises any of an onboard battery for powering the vehicle, mobile phones or smart phones, portable music players, tablet computers, cameras, and the like.

3. The charging system of claim 1, wherein the wind scoop includes a shape and size suitable for being coupled with the vehicle.

4. The charging system of claim 1, wherein the wind scoop includes multiple mounting holes for receiving hardware fasteners suitable for attaching the wind scoop to the hood of the vehicle.

5. The charging system of claim 1, wherein the one or more air inlets comprises a single air inlet configured to receive the airstream during forward motion of the vehicle.

6. The charging system of claim 1, wherein one or more air outlet ports are disposed at a rear of the wind scoop and configured to allow the airstream to exit the wind scoop.

7. The charging system of claim 1, wherein the wind turbine includes multiple blades coupled with a hub that is in mechanical communication with one or more electric generators.

8. The charging system of claim 7, wherein the multiple blades generally are arranged in a cylindrical configuration.

9. The charging system of claim 7, wherein each of the multiple blades includes a scooped cross-sectional shape that extends along the length of the blade.

10. The charging system of claim 7, wherein the multiple blades are configured to turn the one or more electric generators in response to the airstream entering through the one or more air inlets and exiting through one or more air outlet ports at a rear of the wind scoop.

11. The charging system of claim 7, wherein transmission gears are configured to communicate rotation of the multiple blades and the hub to a shaft extending to each of the one or more electric generators.

12. The charging system of claim 11, wherein the transmission gears and the shafts are configured to cause the one or more electric generators to produce an electric current in response to rotation of the multiple blades.

13. The charging system of claim 7, wherein the multiple blades are configured to be axially mounted onto the hood such that the multiple blades remain free to rotate.

14. The charging system of claim 1, further including a circuit box configured to combine the electric current from the one or more electric generators into a combined, useable electric current.

15. The charging system of claim 14, further including a power cable extending from the circuit box and configured to direct the useable electric current to one or more electronic devices.

16. A method for a charging system for a vehicle, the method comprising:
configuring a wind scoop to be coupled with a hood of the vehicle;
disposing one or more air inlets in the wind scoop;
configuring the one or more air inlets to receive an airstream during forward motion of the vehicle;
forming one or more air outlet ports at a rear of the wind scoop;
disposing a wind turbine within the wind scoop and rearward of the one or more air inlets;
configuring the wind turbine to be turned by the airstream; and
configuring a power cable to direct an electric current from the wind turbine to one or more electronic devices that are configured to utilize the electric current.

17. The method of claim 16, wherein configuring the wind turbine includes configuring multiple blades to turn one or more electric generators in response to the airstream entering through the one or more air inlets and exiting through the one or more air outlet ports.

18. The method of claim 17, wherein configuring the wind turbine further includes coupling the multiple blades with a hub that is in mechanical communication with the one or more electric generators.

19. The method of claim 17, wherein configuring the wind turbine further includes configuring transmission gears to communicate rotation of the multiple blades and the hub to a shaft extending to each of the one or more electric generators such that rotation of the multiple blades causes the one or more electric generators to produce the electric current.

20. The method of claim 16, wherein configuring the power cable further includes configuring a circuit box to combine the electric current from the one or more electric generators into a combined, useable electric current.

21. The method of claim 20, wherein configuring the power cable further includes configuring a power cable extending from the circuit box to direct the useable electric current to the one or more electronic devices.
